(19) United States
(12) Patent Application Publication
(10) Pub. No.: US 2009/0094313 A1
(43) Pub. Date: Apr. 9, 2009

(54) SYSTEM, METHOD, AND COMPUTER PROGRAM PRODUCT FOR SENDING INTERACTIVE REQUESTS FOR INFORMATION

(76) Inventor: Jay Feng, San Jose, CA (US)

Correspondence Address: Zilka-Kotab, PC, P.O. BOX 721120, SAN JOSE, CA, 95172-1120, US

(21) Appl. No.: 11/866,956

(22) Filed: Oct. 3, 2007

(51) Int. Cl. G06F 15/16

(52) U.S. Cl. 709/203

(57) ABSTRACT

A system, method, and computer program product are provided for sending interactive requests for information. In use, a user request for digital information from a user system is identified at an interactive system. Additionally, interactive requests for additional information are sent from the interactive system to the user system and a third party system, in response to the user request. Further, a response to the user request is generated, utilizing the additional information. Moreover, the response is sent from the interactive system to the user system.

### FIELD OF THE INVENTION

The present invention relates to information requests, and more particularly to generating responses to information requests.

### BACKGROUND

Networks have traditionally been utilized for remote communications between various network systems. As a result, networks, such as the Internet, have provided platforms for communicating a wide variety of information between remote network systems. Just by way of example, such information has included advertisements, video, web pages, etc.

However, techniques for identifying information to be communicated over networks have generally exhibited various limitations. For example, oftentimes the relevance of information communicated to a destination is based on limited knowledge of the destination. Thus, such information communicated to the destination is frequently ineffective, inadequate, etc. As another example, identifiable information is oftentimes static, and therefore incapable of being customized to the destination to which it is sent.

There is thus a need for addressing these and/or other issues associated with the prior art.

### SUMMARY

A system, method, and computer program product are provided for sending interactive requests for information. In use, a user request for digital information from a user system is identified at an interactive system. Additionally, interactive requests for additional information are sent from the interactive system to the user system and a third party system, in response to the user request. Further, a response to the user request is generated, utilizing the additional information. Moreover, the response is sent from the interactive system to die user system.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for sending interactive requests for information, in accordance with one embodiment.

FIG. 4 shows a system for sending interactive requests for information, in accordance with another embodiment.

FIG. 5 shows a method for creating an information resource, in accordance with yet another embodiment.

FIG. 6 shows a method for creating a response to a user action, in accordance with still yet another embodiment.

FIG. 7 shows a method for creating a response to a user action, in accordance with another embodiment.

FIG. 8 shows a method for creating a conclusion based on an interactive response, in accordance with yet another embodiment.

### DETAILED DESCRIPTION

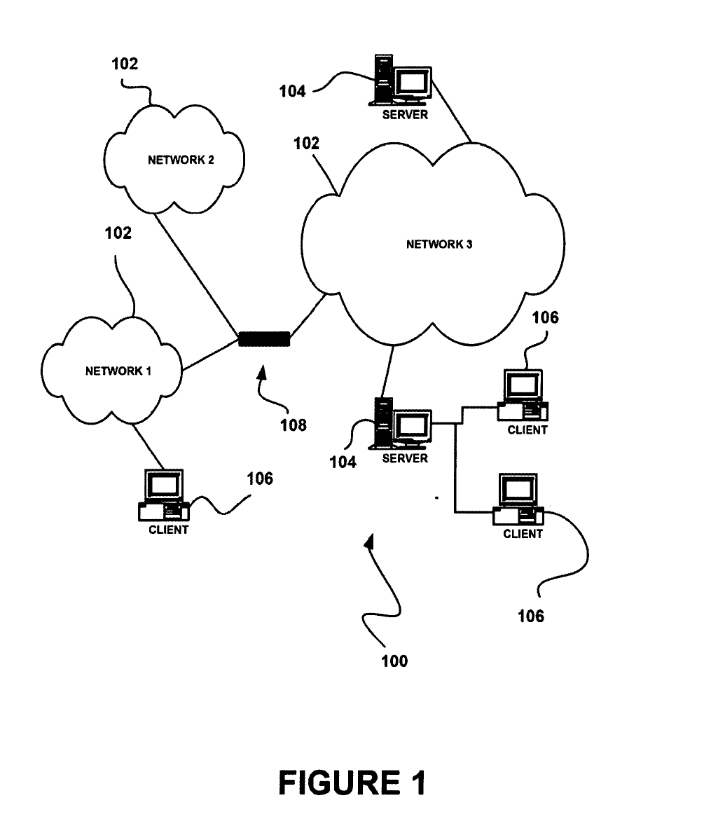

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

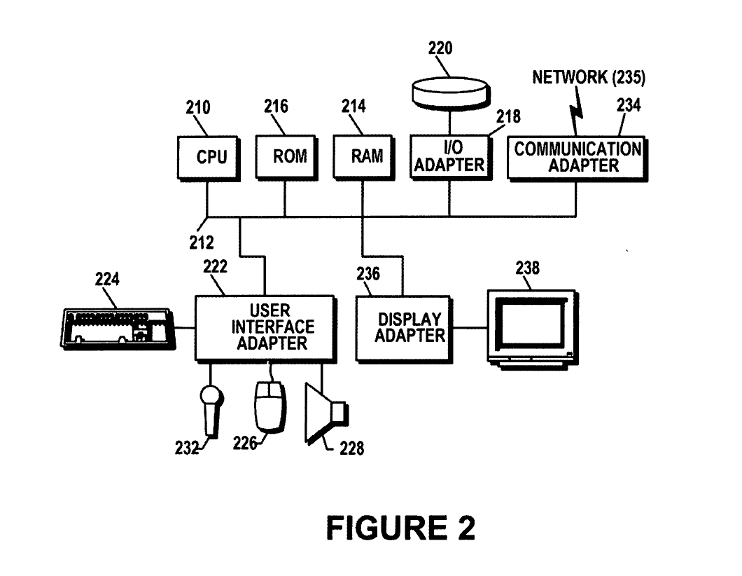

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 [e.g. network card, modem, wireless fidelity (WIFI) device, etc.] for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

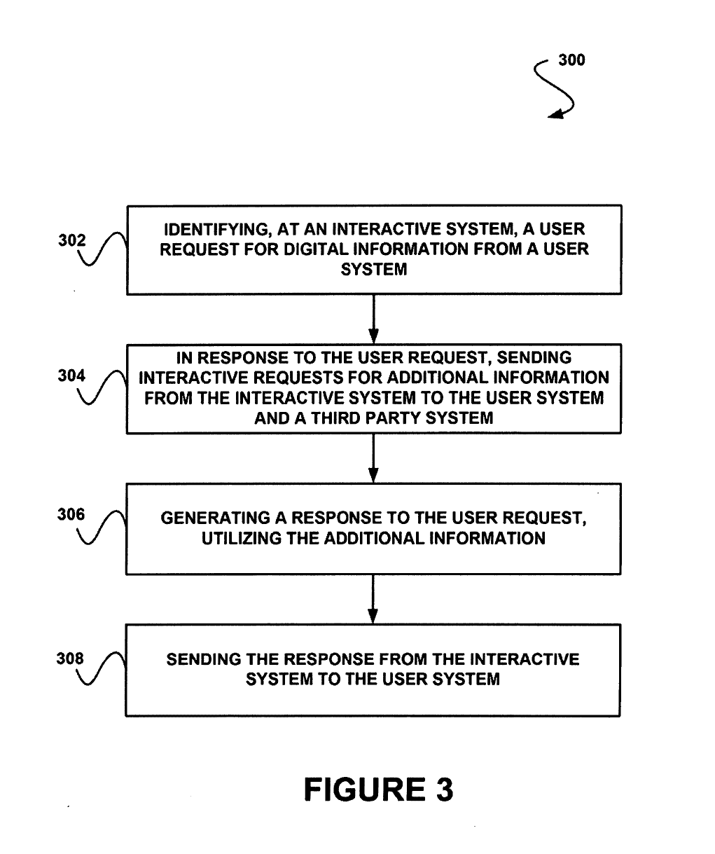

FIG. 3 shows a method 300 for sending interactive requests for information, in accordance with one embodiment. As an option, the method 300 may be carried out in the context of the architecture and environment of FIGS. 1 and/or 2. Of course, however, the method 300 may be carried out in any desired environment.

As shown in operation 302, a user request for digital information from a user system is identified at an interactive system. In the context of the present description, the digital information may include any content (e.g. data, etc.) of digital form capable of being requested from a user system. For example, the digital information may include a web page, video, audio, an electronic mail (email) message, text, hypertext transfer markup language (HTML), an animation, executable instructions, applications, protocols and/or interfaces (e.g. to other systems), etc.

Accordingly, the user request for the digital information may include any request initiated by a user of the user system to access the digital information, download the digital information, receive the digital information, etc. Optionally, the request may be initiated by the user utilizing a graphical user interface (GUI) of the user system. For example, the request may be initiated via a web browser of the user system.

In addition, the user system may include any device from which a user request may be identified that is capable of being utilized by the user. Just by way of example, the user system may include a desktop computer, wireless computer, and/or any of the devices described above with respect to FIGS. 1 and/or 2. Further, the user system may be in communication with a network (e.g. such as any of the networks described above with respect to FIG. 1, etc.). Thus, the user request may include a request to receive the digital information over the network.

Still yet, the interactive system may include any logic (e.g. code, etc.) capable of identifying the user request. In one embodiment, the interactive system may be separate from (e.g. remotely located with respect to) the user system. For example, the interactive system may include a device (e.g. server, etc.) in communication with the user system over the network. In this way, the user request may be communicated over the network for being identified by the interactive system, as an option.

In another embodiment, the interactive system may be local with respect to the user system. Just by way of example, the interactive system may be a component of (e.g. installed on, etc.) the user system. Thus, the interactive system may optionally be capable of intercepting user requests prior to such requests being communicated over the network.

Moreover, the interactive system may identify the user request in any desired manner. In one embodiment, the interactive system may identify packets communicated from the user system. Such identified packets may then be filtered for identifying packets associated with user requests. In another embodiment, the interactive system may identify user requests via an application from which such user requests are generated, such as, for example, a web browser.

As also shown, interactive requests for additional information are sent from the interactive system to the user system and a third party system, in response to the user request. Note operation 304. Such third party system may include any system that is different from the user system and that is capable of receiving an interactive request. For example, the third party system may include another device on the network. In various exemplary embodiments, the third party system may include an advertisement system that stores advertisements, a content system which stores content, etc.

Additionally, in the context of the present description, the interactive requests may include any interactive requests for the additional information. Just by way of example, the interactive requests may include queries for the additional information. As another example, the interactive requests may be communicated to the user system and the third party system over the network.

Further, the interactive requests may be generated at any desired communication protocol layer. Thus, in one embodiment, the interactive requests may be generated utilizing a high level protocol. For example, the high level protocol may allow high level interactive requests to be sent, where such high level interactive requests encompass multiple data points.

In this way, additional information received in response to a single high level interactive request may be capable of being deconstructed into multiple points of additional information. Such deconstruction may be performed utilizing mapping of tie additional information, etc. Just by way of example, a high level interactive request may request that the user system indicate whether a user of such user system is a teenager. If the user system responds with additional information indicating that the user is a teenager, such response may be deconstructed into multiple points of additional information, such as a precise age of the user, preferences of the user, an education level of the user, etc. Of course, it should be noted that in other embodiments the interactive requests may be generated utilizing a low level protocol, such that a response to a single interactive request includes a single data point.

Moreover, the additional information for which the interactive requests are sent may include any information that is at least potentially stored on, accessible by, etc. the user system and/or the third party system. In one embodiment, the additional information may include information associated with the user system. For example, the additional information may include an operating system of the user system, applications installed on the user system, a processing speed of the user system, etc.

In another embodiment, the additional information may include information associated with the user (e.g. a user account, etc.) of the user system. With respect to the user, the additional information may include an age of the user, a location of the user, a demographic of the user, preferences of the user, etc. In yet another embodiment, the additional information may include information associated with the digital information requested by the user system. Optionally, the additional information may include any portion of the requested digital information.

In still yet another embodiment, the additional information may include other information relevant to the user, user system, digital information requested, etc. For example, the additional information may include knowledge, algorithms, applications, programs, code, problem-solving solutions, advertisements, video, audio, manuals, instructions, etc.

It should be noted that while various embodiments of additional information requested via the interactive requests have been described herein, any combination of such additional information may be requested via the interactive requests. Just by way of example, the interactive system may send an interactive request for information associated with the user system to the user system. In addition, the interactive system may send an interactive request for information associated with the requested digital information to the third party system (e.g. such as a system which stores advertisements, etc.). Thus, the interactive system may send interactive requests for different types of additional information to the user system and the third party system.

Furthermore, a response is generated to the user request, utilizing the additional information, as shown in operation 306. Optionally, the response may be generated utilizing the interactive system. As another option, the additional information may be received (e.g. by the interactive system) from the user system and/or the third party system for generating the response.

In the context of the present description, the response may include any response capable of being generated utilizing the additional information. Optionally, such response may also be generated utilizing information stored (e.g. in a database, etc.) with respect to the interactive system. In one embodiment, the response may include the digital information requested by the user system (in operation 302).

In another embodiment, the response may include other information that is different from the digital information requested by the user system. For example, the response may include an advertisement, an update to an application installed on the user system, information associated with (e.g. similar to, etc.) the digital information requested by the user system, an application requested by the user system, etc. Of course, the response may also include any combination of the digital information requested by the user system and the other information.

Additionally, the response may be generated in any desired manner In one embodiment, the response may be generated directly (hereinafter also referred to as intuitively) utilizing the additional information. For example, the response may be generated by creating packets for communicating the additional information (e.g. in the form received by the user system and/or the third party system). As another example, the response may be generated by creating a mailing for communicating the additional information.

In another embodiment, the response may be generated utilizing the additional information based on reasoning. For example, the additional information may be analyzed and/or processed (e.g. into a different format, etc.). Optionally, the analysis may be context-dependent. Just by way of example, the types of analysis performed on the additional information may be based on the additional information. As another option, the processing of the additional information may include serial processing, parallel processing, etc.

As another example, the additional information may be disassembled and any desired portions of the additional information reorganized into the response. Thus, the response may include a combination of additional information received from the user system and the third party system. Further, the response may be customized to the user system based on at least a portion of the additional information, such as the additional information received from the user system.

As another option, the response may include reorganized portions of the additional information that create the digital information requested by the user system. In this way, if the interactive system is unable to identify the digital information requested (e.g. such as a computer program, etc.), the interactive system may create such digital information utilizing the additional information.

Moreover, the response is sent from the interactive system to the user system, as shown in operation 308. In one embodiment, the response may be sent to the user system from the interactive system over the network. Optionally, the response may be sent to the user system by pushing the response to the user system, downloading the response to the user system, etc. Of course, however, the response may be sent to the user system from the interactive system in any desired manner.

To this end, the response may be generated based on additional information received from the user system and/or the third party system, and may be sent to the user system based on the user request for digital information. In one embodiment, the interactive requests for additional information may be sent to the user system and the third party system in response to a lack of sufficient information associated with the user request. For example, the interactive system may lack information sufficient for identifying, accessing, locating, etc. the digital information. Thus, the interactive requests may be utilized for determining sufficient information (e.g. the digital content requested, etc.) to generate the response to the user request.

In another embodiment, the interactive requests for additional information may be sent in response to contradictory information associated with the user request. Just by way of example, the interactive system may include first information that is contradictory to second information also included in the interactive system. Thus, the interactive requests may be utilized for determining whether the first information or the second information is to be utilized in generating the response to the user request. Accordingly, the interactive requests may allow a response relevant to the user system, user, digital information requested, etc. to be generated and sent to the user system.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

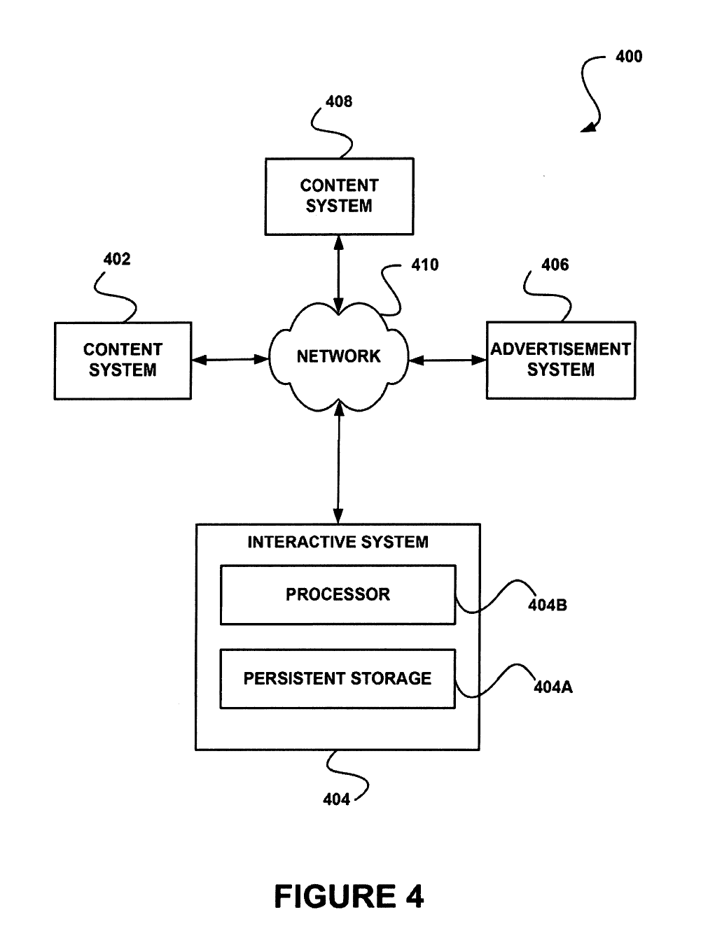

FIG. 4 shows system 400 for sending interactive requests for information, in accordance with another embodiment. As an option, the system 400 may be implemented in the context of the architecture and environment of FIGS. 1-3. Of course, however, the system 400 may be implemented in any desired environment. It should also be noted that the aforementioned definitions may apply during the present description.

As shown, an interactive system 404 is in communication with a user system 402, an advertisement system 406, and a content system 408 via a network 410. As another option, the interactive system 404 may be included on a server, a gateway, etc. While the interactive system 404 is shown as being in communication with such user system 402, advertisement system 406, and content system 408 remotely over a network, it should be noted that, in other various embodiments, the interactive system 404 may be installed on any of the user system 402, advertisement system 406, and content system 408. Further, while only such user system 402, advertisement system 406, and content system 408 are shown, in yet other embodiments, the interactive system 404 may be in communication with any other systems (e.g. expert systems, database systems, etc.).

The network 410 may include network wires, servers, switches, routers, a modem, a firewall, memory, a persistent storage device (e.g. hard disk drive, etc.), a central processing unit (CPU), etc. In addition, the network 410, the interactive system 404, the user system 402, the content system 408, and/or the advertisement system 410 may include executable instructions/algorithms, an expert system, a knowledge base, a database, etc.

Further, the interactive system 404 may be capable of publishing information, such as advertisements, etc. The user system 402 may optionally be capable of identifying users of the user system 402 (e.g. via user accounts), and information associated with such users (e.g. psychology, motivation, needs, behaviors, models of thinking, etc.), etc. Also, the content system 408 may store information, such as web pages, etc. Still yet, tie advertisement system 410 may store advertising information, including, for example, advertisement templates, advertisements, etc.

Thus, the interactive system 404 may be capable of identifying a user request for digital information communicated from the user system 402. For example, the user system 402 may communicate the user request over the network 410 to the interactive system 404. As another example, the user system 402 may communicate the user request over the network 410 and the interactive system 404 may intercept the user request.

In response to receipt of the user request for digital information, the interactive system 404 may be further capable of determining whether the requested digital information is stored in persistent storage 404A of the interactive system 404. The interactive system 404 may also be capable of determining whether the persistent storage 404A stores other information (e.g. advertisements, user information, etc.) relevant to the requested digital information. Thus, the persistent storage 404A may include a database of information, for example.

Optionally, the interactive system 404 may create a strategy for responding to the user request for the digital information. As another option, multiple strategies may be created for responding to the user request for the digital information. In one embodiment, multiple strategies may be associated with a sequence predetermined by the interactive system 404, such that the strategies may be implemented according to such sequence. Additionally, the strategy may be complete, incomplete, etc. Further, the strategy may change over time.

For example, the strategy may identify a type of information (e.g. the requested digital information, other information, etc.) to be included in a response to the user system 402. The type of information may be based on the requested digital information, in one embodiment. For example, the type of information may include information useful, supportive, etc. to the user system 402, such as the digital information requested by the user system 402, other information describing the digital information requested, etc. Thus, the relationship between the interactive system 404 and the user system 402 may be cooperative, friendly, etc.

The type of information may also include ineffective, misleading, etc. information. Just by way of example, if the user system 402 requests malware (e.g. a virus, etc.), the strategy may indicate that only information that does not contain malware (e.g. an alert, etc.) is to be included in the response to the user system 402. As another example, the uncooperative, etc. strategy may indicate that the interactive system 404 is to provide other information to the user system 402 than the digital information requested by the user system 402, such as a different web site, an instruction to shut down the user system 402, etc.

In this way, the relationship between the interactive system 404 and the user system 402 may be uncooperative, hostile, rival, etc. Optionally, such strategy may be utilized by an anti-malware (e.g. anti-virus, anti-spyware, intrusion detection, etc.) system that implements the interactive system 404. Still yet, the strategy may change over time based on various factors. Such factors may include information stored in the persistent storage 404A of the interactive system 404, information received by the interactive system 404, etc.

In another embodiment, the strategy may include at least one objective. Objectives may each identify additional information to be requested from the user system 402 and at least one of the advertisement system 406 and the content system 408. The objectives may thus indicate additional information possibly needed for generating the response the user request. The objectives may optionally be maintained by the interactive system 404, regardless of actions of the user system 402.

As an option, the objectives may be fuzzy (e.g. imprecise, etc.). As another option, the strategy may include a hypothetical strategy with hypothetical objectives, for example, when the objectives may be unknown. Such hypothetical strategy may be validated if additional information identified based on the hypothetical objectives is capable of being utilized to generate the response to the user request.

In one embodiment, the objectives may be based on the information stored in the persistent storage 404A of the interactive system 404. For example, the objectives may indicate additional information not found in the persistent storage 404A. In another embodiment, the objectives may be based on information received in the user request sent from the user system 402.

In yet another embodiment, the objectives may be based on historical information. Such historical information may include characteristics of the user system 402, previous behaviors of the user system 402, expert predicted information, relevant information associated with a system similar to the user system 402, previous communications associated with the user system 402 (e.g. which may be completed, incomplete or discontinuous), etc. Accordingly, the objectives, and therefore strategy, may be created dynamically based on the historical information.

In one embodiment, the interactive system 404 may determine that the persistent storage 404A stores incomplete information associated with the digital information requested. In the context of the present embodiment, the information stored in the persistent storage 404A may be incomplete if the information is incapable of being utilized to generate a response to the user request for the digital information. In one embodiment, the incomplete information may be incapable of being utilized to generate the requested digital information. In another embodiment, the incomplete information may be incapable of being utilized to generate other information (e.g. an advertisement, etc.) relevant to the requested digital information, a user of the user system 402, etc.

In response to a determination that the persistent storage 404A stores incomplete information associated with the digital information requested, the interactive system 404 may send interactive requests for additional information to the user system 402 and at least one of the advertisement system 406 and the content system 408. The interactive requests may be utilized for gathering the additional information. The interactive requests may also be based on objectives of the strategy. For example, the interactive requests may request additional information capable of being utilized to complete the information stored in the persistent storage 404A that is associated with the digital information requested.

Accordingly, the interactive system 404 may receive interactive responses that include any portion of the requested additional information from the user system 402, the advertisement system 406 and/or the content system 408. The received additional information may therefore be utilized by the interactive system 404 to generate a response to the user request for digital information. Of course, it should be noted that the interactive system 404 may send any number of different interactive requests for additional information to the user system 402, the advertisement system 406 and/or the content system 408.

As another option, the interactive system 404 may utilize reasoning (e.g. including historical data, etc.) with respect to incomplete additional information received from the user system 402, the advertisement system 406 and/or the content system 408 for deducing any incomplete information. As shown, the interactive system 404 includes a processor 404B, and such processor 404B may be utilized for performing the reasoning.

In another embodiment, the interactive system 404 may determine that the persistent storage 404A stores contradictory information associated with the digital information requested. Such contradictory information may include first information stored in the persistent storage 404A that contradicts second information stored in the persistent storage 404A, for example. Thus, the interactive system 404 may send interactive requests to the user system 402 and at least one of the advertisement system 406 and the content system 408 for additional information.

Such additional information may accordingly be utilized by the interactive system 404 for determining which contradictory information to utilize in generating a response to the user request for the digital information. For example, the processor 404B of the interactive system 404 may be utilized for analyzing and/or processing the additional information in order to make such determination. As another option, the determination of which contradictory information to utilize may be based on historical information. Of course, the determination of which contradictory information to utilize may be made by selecting the information with a majority of other information that supports it or with a minority of other information that supports it.

In still yet another embodiment, the interactive system 404 may determine that the persistent storage 404A stores fuzzy information associated with the digital information requested. In the context of the present embodiment, the fuzzy information may include information that is imprecise, ambiguous, etc. For example, the fuzzy information may contain terms such as “very”, “probably”, etc., may change according various contexts and conditions in which it is used, may have multiple meanings, etc.

As an option, the interactive system 404 may send interactive requests for additional information to the user system 402 and at least one of the advertisement system 406 and the content system 408. Such additional information may then be analyzed and/or processed by the processor 404B of the interactive system 404 for identifying precise information capable of being utilized to generate a response to the user request for the digital information. As another option, the processor 404B of the interactive system 404 may utilize fuzzy logic, fuzzy knowledge, etc. for processing the fuzzy information. For example, such fuzzy logic, etc. may be similar to that utilized in fuzzy mathematics associated with computer vision, artificial intelligence, automated control, data processing, etc.

As an option, the interactive system 404 may store any additional information received from the user system 402, the advertisement system 406 and/or the content system 408, in addition to any information deduced by the interactive system 404, in the persistent storage 404A. Thus, the interactive system 404, including any code associated therewith, may be modified based on received additional information. As another option, the interactive system 404 may send interactive requests in response to the receipt of additional information that is incomplete, fuzzy, contradictory, etc.

In this way, the interactive system 404 may send interactive requests for additional information to the user system 402, the advertisement system 406, and/or the content system 408 via the network 410. Such interactive requests may be sent by the interactive system 404 for proactively receiving the additional information and/or passively receiving the additional information.

The interactive requests may be sent via conversations (e.g. queries, etc.), in one embodiment. The conversations may include any exchange of information. For example, a conversation may include the sending of an interactive request in addition to the sending of an interactive response associated with such interactive request to the interactive system 404. In one embodiment, the interactive system 404 may alert the user system 402, the advertisement system 406, and/or the content system 408, in order to make such systems aware of the interactive system 404. Thus, conversations may be performed with systems aware of the interactive system 404, as an option.

Further, the conversations may be of any desired form, such as text-based, audio-based, video-based, etc., and/or any combination thereof. In one embodiment, each conversation may be associated with a single objective of the strategy, multiple objectives of the strategy, etc. Thus, a conversation may be utilized for receiving from the user system 402, the advertisement system 406, and/or the content system 408 a single type of additional information and/or multiple different types of additional information.

Optionally, an interactive request may be sent via a single conversation or multiple conversations. Multiple conversations associated with a single interactive request may include contiguous conversations, separated conversations (e.g. discrete in time), segmented conversations, direct conversations (e.g. directly communicated between the interactive system 404 and the user system 402/advertisement system 406/content system 408), indirect conversations (e.g. indirectly communicated between the interactive system 404 and the user system 402/advertisement system 406/content system 408 via a intermediary system), etc. Optionally, the multiple conversations may also be sequential, out of order, random, etc.

In response to receiving such interactive requests, the user system 402, the advertisement system 406, and/or the content system 408 may store the interactive requests (e.g. in volatile memory, persistent storage, etc.), and may further process and respond to such interactive requests via interactive responses. The interactive responses may be in any desired format, such as text, images, video, music, games, etc. The interactive responses may also include a single type of information, multiple types of information, etc. Additionally, the interactive responses may be incomplete, fuzzy, contradictory, etc. Thus, the interactive responses may result in the interactive system 404 dynamically adjusting the strategy (e.g. by refining objectives, etc.), and accordingly sending further interactive requests for yet additional information.

In some embodiments, the user system 402, the advertisement system 406, and/or the content system 408 may fail to respond to the interactive requests. For example, a conversation associated with an interactive request may be interrupted. As an option, the interactive system 404 may determine whether to continue the conversation (e.g. by resending the interactive request, etc.), terminate the conversation and begin another conversation with a different system, etc. Such determination may be based on whether any additional information has been received by the interactive system 404.

In other embodiments, the user system 402, the advertisement system 406, and/or the content system 408 may send interactive responses to the interactive system 404 that are relevant to the interactive requests (e.g. that provide the information requested by the interactive requests), that are empty (e.g. that do not provide any additional information), and/or that are ineffective (e.g. that are misleading to the interactive system 404, etc.). Further, such interactive responses may be sent to the interactive system 404 upon receiving the interactive requests, but of course may also be delayed.

Once the interactive system 404 receives the interactive responses, the interactive system 404 may dynamically adjust the strategy based on such interactive responses, as noted above, or may generate a response to the user request for the digital content. For example, the interactive system 404 may generate the response if the additional information included in the interactive responses meets the strategy of the interactive system 404. In one embodiment, the interactive system 404 may wait a predetermined period of time before generating the response.

In one optional embodiment, the response may be generated by disassembling the additional information received via the interactive responses into portions. Further, any desired portions of the additional information, and optionally information stored in the persistent storage 404A of the interactive system 404, may be reassembled into an information resource to be included in the response. Such information resource may optionally be precise, fuzzy, etc. Thus, the response may include a combination of additional information received from the user system and a third party system. Just by way of example, the response may include an application generated by utilizing a plurality of modules of code received via the interactive responses.

As an option, the information included in the response may have multiple beginnings, endings, paths, etc., based on the organization of such information by the interactive system 404. For example, the beginnings may include starting points for the information, the endings may include ending points for the information, and the paths may include the course via which the information is presented. Such reassembling may allow targeted advertisements or other content to be included in the response. Moreover, the interactive system 404 may send the generated response to the user system 402 over the network 410.

In one exemplary embodiment, a user of the user system 402 may browse information on the network 410 utilizing a web browser of the user system 402. The user may request digital content, such as a web page, via the web browser. Such request may then be sent to content system 408 over the network 410. The content system 408 may create HTML content capable of being displayed via the web browser of the user system 402, and may send such HTML content to the user system 402. The HTML content may be stored in volatile memory of the user system 402, and may be displayed to the user via the web browser.

The HTML content sent to the user system 402 may also have embedded therein the interactive system 404. Optionally, the content system 408 may embed the interactive system 404 in the HTML content during generation of such HTML content. With respect to the present example, the interactive system 404 may be utilized for generating advertisements for display on the user system 402. Thus, the interactive system 404 may be installed on the user system 402 in response to the user system 402 receiving the HTML content.

The interactive system 402 may then identify information associated with the user system 402 (e.g. by monitoring actions performed by the user system 402, collecting information associated with properties of the user system 402, etc.). For example, the interactive system 404 may identify cookies stored on the user system 402. In response to an additional user request by the user system 402 for digital information, the interactive system 402 may generate a strategy for generating an advertisement associated with such requested digital information. For example, the advertisement may be relevant to the type of digital information requested.

Based on such strategy, the interactive system 404 may send interactive requests to the advertisement system 406 and the user system 402 for gathering additional information to be utilized in generating the response to the user request for the digital information. Optionally, the interactive request sent to the advertisement system 406 may include a request for an advertisement template associated with the type of digital information requested by the user system 402, whereas the interactive request sent to the user system 402 may include a request for information associated with a user account being utilized on the user system 402. In response to receiving the interactive requests, the user system 402 and the advertisement system 406 may send interactive responses with the additional information requested.

The interactive system 404 may accordingly generate an advertisement customized to the user of the user system 402 utilizing such additional information (e.g. by deconstructing, reassembling, etc. the additional information). For example, the interactive system 404 may combine the advertisement received from the advertisement system 406 and the user information received from the user system 402 sequentially, mixed, etc. As another example, the interactive system 404 may deconstruct such advertisement and user information into modules capable of performing conversations. Such modules may also be combined sequentially, mixed, etc. The customized advertisement may then be sent to the user system 402 with the digital information requested by the user system 402.

In another exemplary embodiment, a user of the user system 402 may request a digital image of a famous athlete and a ticket to an athletic event. The interactive system 404 may receive a user request from the user system 402 indicating the image and the ticket requested. The interactive system 404 may determine whether its persistent storage 404A includes the requested information.

In response to a determination by the interactive system 404 that the persistent storage 404A only includes the digital image requested, the interactive system 404 creates a strategy indicating that information associated with the ticket is to be gathered. Thus, the interactive system 404 may send an interactive request to the user system 402 for additional information about the requested ticket, such as a date of the athletic event, etc.

The interactive system 404 may also send an interactive request to the content system 408, which in the context of the present example, may store available athletic event tickets. Such interactive request may request additional information based on the additional information received from the user system 402, such as a price of the ticket, availability of the ticket, etc. In response to receiving the additional information requested from the user system 402 and the content system 408, the interactive system 404 may generate a response to the user request for the digital image and the ticket. For example, the response may include the digital image and information associated with the ticket. If, however, additional information is not received by the user system 402 or the content system 408, the interactive system 404 may adjust its strategy and may send another interactive request to accordingly gather additional information indicated by the strategy.

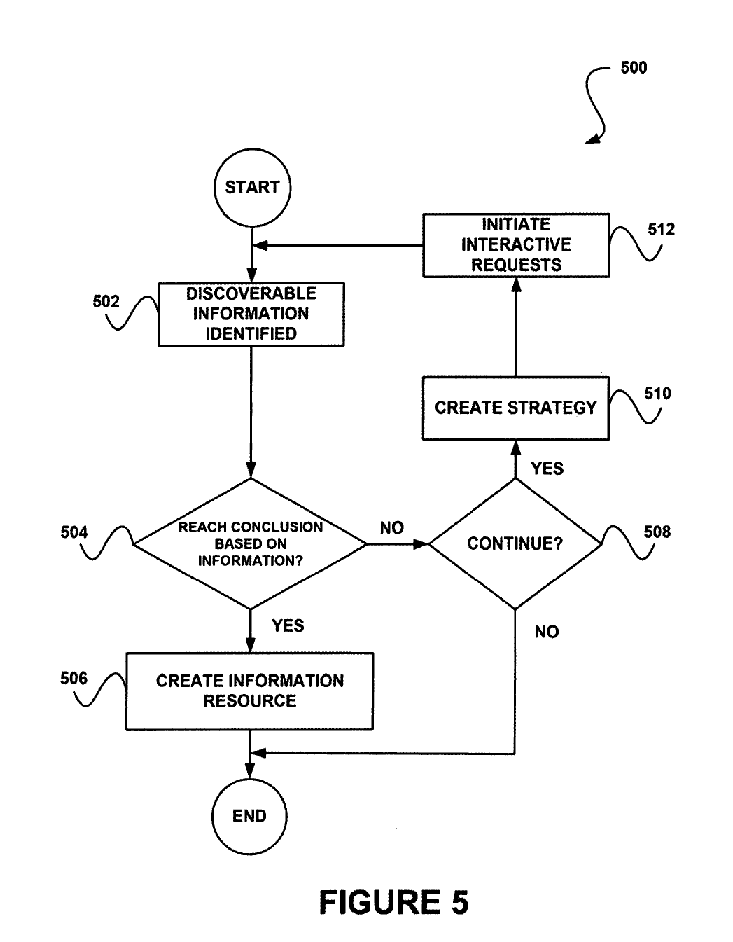

FIG. 5 shows a method 500 for creating an information resource, in accordance with yet another embodiment. As an option, the method 500 may be carried out in the context of the architecture and environment of FIGS. 1-4. Of course, however, the method 500 may be carried out in any desired environment. Again, it should also be noted that the aforementioned definitions may apply during the present description.

As shown in operation 502, discoverable information is identified. In the context of the present embodiment, the discoverable information may include information associated with a user request for digital information. For example, the discoverable information may include properties of a user system from which the user request was issued, data and/or signals identified from the user system, a purchase made utilizing the user system, a registration performed by the user system, a login associated with the user system, mouse clicks performed with respect to the user system, keystrokes performed with respect to the user system, audio, video and/or text entered via the user system, etc. In other embodiments, the discoverable information may include preferences associated with a user of such user system, advertisements relevant to the digital information requested, etc.

In one embodiment, the discoverable information may be identified utilizing an interactive system. Optionally, the interactive system may query an associated database for the discoverable information. Such database may include census information, historical behavior of users of various user systems, psychological characteristics of users, information associated with a group related to the user, predicted information from experts (e.g. such as from die analysis of psycho-behavior scientists), etc. Just by way of example, the interactive system may query the database for an identifier of the user.

As another option, the interactive system may perform conversations with the user system and/or a third party system. For example, the interactive system may send an interactive request to the user system and/or the third party system for the discoverable information. Thus, an interactive response to such interactive request may include the discoverable information. Of course, however, the discoverable information may be identified in any desired manner. Optionally, the interactive system may recognize the user system based on such discoverable information.

Additionally, it is determined whether a conclusion may be reached based on the discoverable information identified. Note decision 504. With respect to the present embodiment, the conclusion may include any predetermined information that may at least potentially be included in the discoverable information. For example, the conclusion may include a characteristic of the user, a determination of a preference of the user, etc. Thus, it may be determined that a conclusion may be reached if it is determined that the predetermined information is included in the discoverable information. As an option, the conclusion may be reached without processing the discoverable information.

In other various embodiments, the conclusion may be reached via concepts, judgments, deductions, etc. in which the discoverable information is processed. Still yet, the interactive system may utilize analysis, synthesis, abstraction, summarizing, embodiments, etc. for processing the discoverable information to reach a conclusion. Furthermore, the conclusion may be capable of being reached based on discoverable information received via a single conversation, multiple conversations, etc.

If it is determined that a conclusion may be reached, an information resource is created, as shown in operation 506. The information resource may include any information capable of being sent to the user system. For example, the information resource may include an advertisement, video, audio, digital information requested by the user, etc. In this way, the information resource may optionally be created directly, without utilizing any reasoning or interactive requests. Further, the information resource may be sent to the user within a response to the user request for digital content.

If, however, it is determined that a conclusion may not be reached, it is determined whether the method 500 is to continue. Note decision 508. Such determination may be based on any desired criteria. In one embodiment, the determination may be based on a timeout. For example, the method 500 may not continue if the information resource associated with the user request has not been created within a threshold amount of time. In another embodiment, the determination may be based on a number of times it has been determined whether a conclusion has been reached (operation 504). If such number exceeds a predefined threshold, the method 500 may not continue. If it determined that the method 500 is not to continue, an alert may be sent to the user system indicating such timeout, etc., as an option.

If it is determined that the method 500 is to continue, a strategy is created, as shown in operation 510. The strategy may include objectives for gathering additional information capable of being utilized to reach a conclusion (in operation 504). For example, the strategy may include identification of an age of the user, a location of the user device, a preference of the user, etc.

Furthermore, interactive requests are initiated, as shown in operation 512. The interactive requests may be initiated based on the strategy. For example, the interactive requests may include queries for information indicated within the strategy. In one embodiment, the interactive requests may be initiated by being sent to the user system and/or various other third party systems.

As shown, further discoverable information is identified based on such interactive requests (operation 502). Such further discoverable information may include information included in interactive responses received in response to the interactive requests. Thus, the further discoverable information may, at least in part, fulfill the objectives of the strategy.

Accordingly, it is again determined whether a conclusion may be reached based on the further discoverable information and the initially discovered information. Note decision 504. Thus, the further discoverable information may optionally satisfy the objectives of the strategy, such that a conclusion may be reached. In this way, an information resource may be created based on additional information identified via an interactive request (operation 506).

Of course, however, the discoverable information may also fail to satisfy the objectives of the strategy. To this end, it may be determined that a conclusion may not be reached, and it may again be determined whether the method 500 is to continue (decision 508). In one embodiment, the method 500 may continue by adjusting the objectives of the strategy and issuing additional interactive requests based on such adjusted objectives.

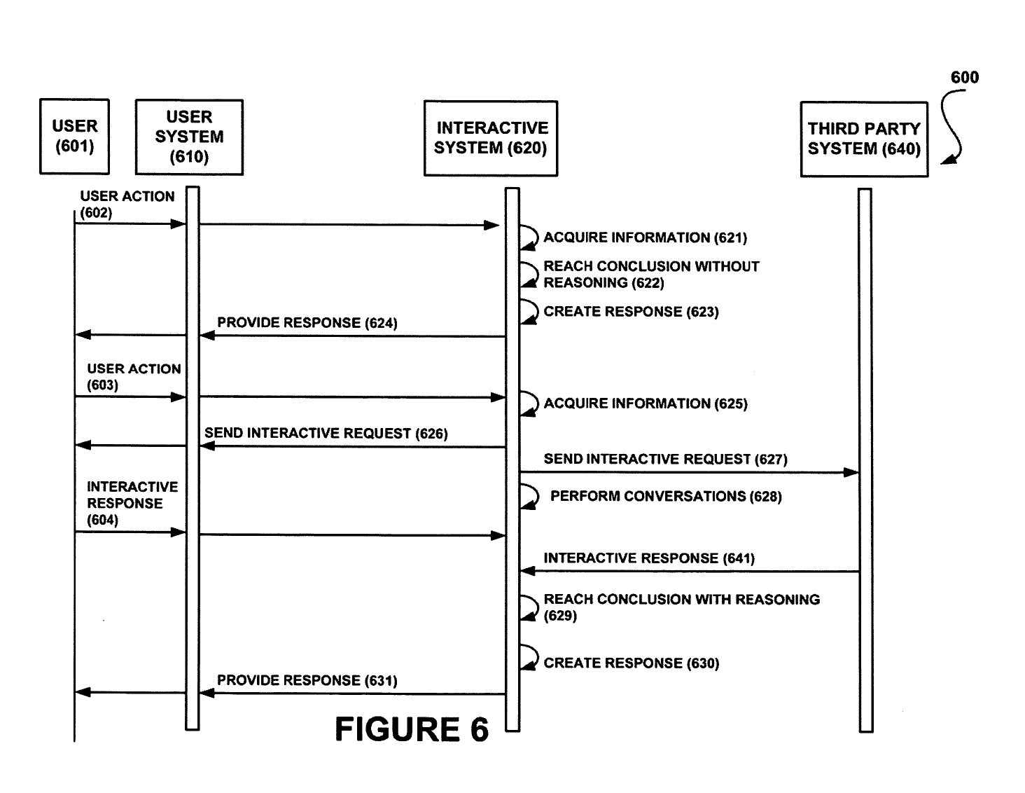

FIG. 6 shows a method 600 for creating a response to a user action, in accordance with still yet another embodiment. As an option, the method 600 may be carried out in the context of the architecture and environment of FIGS. 1-5. Of course, however, the method 600 may be carried out in any desired environment. Again, it should also be noted that the aforementioned definitions may apply during the present description.

In one embodiment, a user action is initiated by a user 601 of a user system 610. Note operation 602. In the context of the present embodiment, the user action may include a user request for digital information. In response to identification of the user action by an interactive system 620, the interactive system 620 acquires information. Note operation 621. Such information may include the requested digital information, for example. Optionally, the interactive system 620 may acquire the information by querying a database of information associated with the interactive system 620. Just by way of example, the interactive system 620 may query the database for the digital information requested by the user 601.

The interactive system 620 then reaches a conclusion without reasoning, as shown in operation 622. For example, the interactive system 620 may determine that the acquired information satisfies the user request for digital information. Thus, the interactive system 620 creates a response (operation 623), and provides such response to the user system 610 (operation 624), which in turn provides (e.g. presents) the response to the user 601. The response may include the acquired information, for example. As another example, the response may be created by organizing and integrating an information resource of the interactive system 620 to implement the conclusion. In this way, the user 601 may receive a response based on the initiated user action.

In another embodiment, another user action is initiated by the user 601 of the user system 610. Note operation 603. Again, the user action may include a user request for digital information. In response to identification of the user action by the interactive system 620, the interactive system 620 acquires information. Note operation 625. Such information may include information associated with the user 601, for example. Optionally, the interactive system 620 may acquire the information by querying a database of information associated with the interactive system 620. Just by way of example, the interactive system 620 may query the database for the information associated with the user 601.

Based on the acquired information, the interactive system 620 sends an interactive request to the user 601 via the user system 620. Note operation 626. Such interactive request may include a request for additional information associated with the user 601, associated with the digital information requested, etc. The interactive system 620 also sends an interactive request to a third party system 640. Just by way of example, the interactive request to the third party system 640 may include a request for additional information associated with the digital information requested.

Thus, the interactive system 620 performs conversations (operation 628) with the user 601 of the user system 610 and the third party system 640. Such conversations may be continuous (e.g. uninterrupted), segmented, etc. During such conversations, the interactive system 620 receives interactive responses from the user 601 (operation 604) and the third party system 640 (operation 641). The interactive responses may provide additional information requested via the interactive requests.

Further, a conclusion is reached with reasoning, utilizing the interactive system 620. Note operation 629. For example, the interactive system 620 may reorganize the additional information to generate a response to the user action. Thus, the interactive system 620 creates a response (operation 630), and provides such response to the user system 610 (operation 631) which in turn provides the response to the user 601. The response may include the additional information, for example. As another example, the response may be created by organizing and integrating an information resource of the interactive system 620 to implement the conclusion. In this way, the user may receive a response based on the initiated user action.

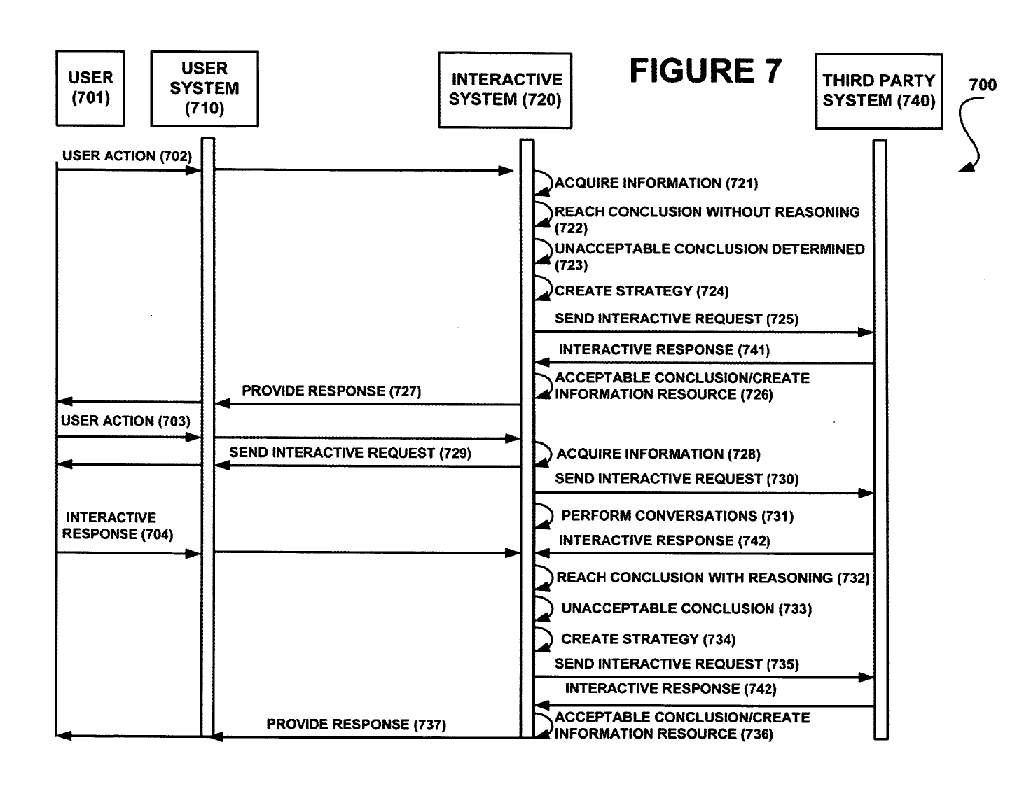

FIG. 7 shows a method 700 for creating a response to a user action, in accordance with another embodiment. As an option, the method 700 may be carried out in the context of the architecture and environment of FIGS. 1-5. Of course, however, the method 700 may be carried out in any desired environment. Yet again, it should also be noted that the aforementioned definitions may apply during the present description.

In one embodiment, a user action is initiated by a user 701 of a user system 710. Note operation 702. In the context of the present embodiment, the user action may include a user request for digital information. In response to identification of the user action by an interactive system 720, the interactive system 720 acquires information. Note operation 721. Such information may include the requested digital information, for example. Optionally, the interactive system 720 may acquire the information by querying a database of information associated with the interactive system 720. Just by way of example, the interactive system 720 may query the database for the digital information requested by the user 701.

The interactive system 720 then reaches a conclusion without reasoning, as shown in operation 722. For example, the interactive system 720 may identify a portion of the digital content in the acquired information. As also shown, the interactive system 720 determines that the conclusion is unacceptable (operation 723). For example, the interactive system 720 may determined that the conclusion is incomplete, contradictory, etc.

Further, a strategy is created by the interactive system 720, as shown in operation 724. An interactive request is then sent to a third party system 740, as shown in operation 725. Optionally, the interactive request may be sent based on the strategy. In response to the interactive request, the third party system 740 sends an interactive response to the interactive system 720 (operation 741). Such interactive response may provide additional information to the interactive system 720.

Also, an acceptable conclusion is reached and an information resource is created (operation 726) by the interactive system 720, based on the interactive response received from the third party system 740. The conclusion may be determined to be acceptable based on a determination that the conclusion is complete, etc. In addition, the information resource may be created by disassembling the additional information received in the interactive response, and optionally only including portions of such additional information in the information resource, or otherwise reorganizing the additional information. Moreover, a response is provided to the user 701 of the user system 710. Note operation 727. For example, the response may include the information resource. As another example, the response may be created by organizing and integrating the information resource of the interactive system 720 to implement the conclusion.

In another embodiment, another user action is initiated by the user 701 of the user system 710. Note operation 703. Again, the user action may include a user request for digital information. In response to identification of the user action by the interactive system 720, the interactive system 720 acquires information. Note operation 728. Such information may include information associated with the user 701, for example. Optionally, the interactive system 720 may acquire the information by querying a database of information associated with the interactive system 720. Just by way of example, the interactive system 720 may query the database for the information associated with the user 701.

Based on the acquired information, the interactive system 720 sends an interactive request to the user 701 via the user system 720. Note operation 729. Such interactive request may include a request for additional information associated with the user 601, associated with the digital information requested, etc. The interactive system 720 also sends an interactive request to a third party system 740 (operation 730). Just by way of example, the interactive request to the third party system 740 may include a request for additional information associated with the digital information requested.

Thus, the interactive system 720 performs conversations (operation 731) with the user 701 of the user system 710 and the third party system 740. Such conversations may be continuous (e.g. uninterrupted), segmented, etc. During such conversations, the interactive system 720 receives interactive responses from the user 701 (operation 704) and the third party system 740 (operation 742). The interactive responses may provide additional information requested utilizing the interactive requests.

The interactive system 720 then reaches a conclusion with reasoning, as shown in operation 732. For example, the interactive system 720 may analyze and/or process the additional information. As also shown, the interactive system 720 determines that the conclusion is unacceptable (operation 733). For example, the interactive system 720 may determined that the conclusion is incomplete, contradictory, etc.

Further, a strategy is created by the interactive system 720, as shown in operation 734. The strategy may indicate the additional information needed to reach an acceptable conclusion. An interactive request is then sent to the third party system 740, as shown in operation 735. Optionally, the interactive request may be sent based on the strategy. In response to the interactive request, the third party system 740 sends an interactive response to the interactive system 720 (operation 742). Such interactive response may provide additional information to the interactive system 720.

Also, an acceptable conclusion is reached and an information resource is created (operation 736) by the interactive system 720, based on the interactive response received from the third party system 740. The conclusion may be determined to be acceptable based on a determination that the conclusion is complete, etc. In addition, the information resource may be created by disassembling the additional information received in the interactive response, and optionally only including portions of such additional information in the information resource, or otherwise reorganizing the additional information. Moreover, a response is provided to the user 701 of the user system 710. Note operation 737. For example, the response may include the information resource. As another example, the response may be created by organizing and integrating the information resource of the interactive system 720 to implement the conclusion.

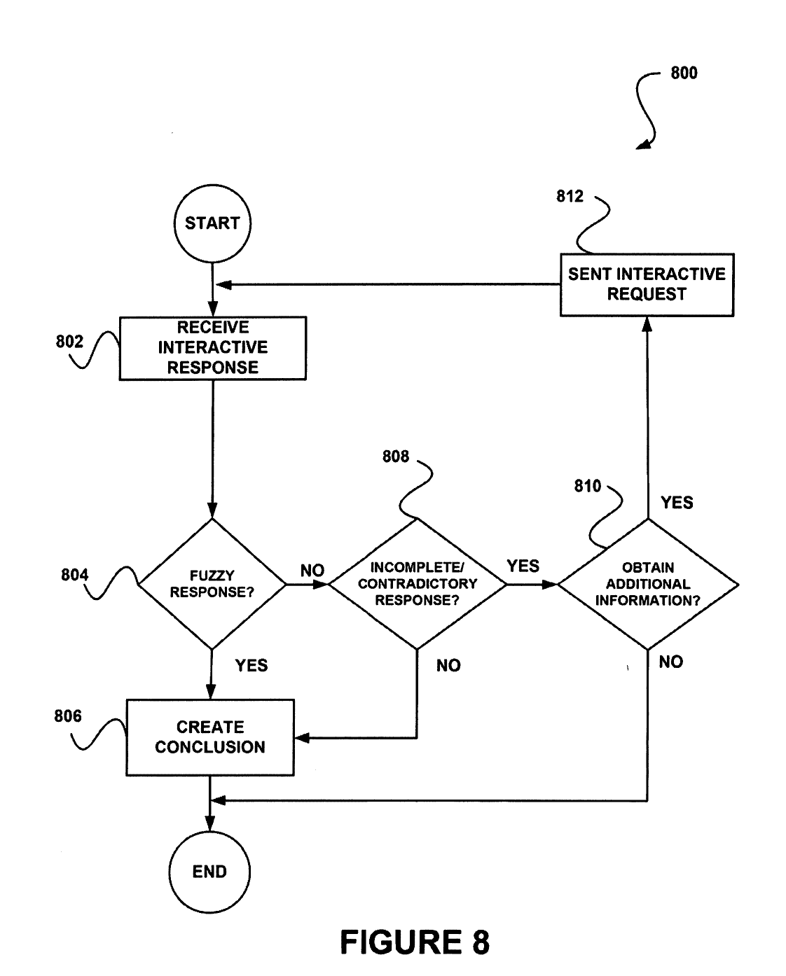

FIG. 8 shows a method 800 for creating a conclusion based on an interactive response, in accordance with yet another embodiment. As an option, the method 800 may be carried out in the context of the architecture and environment of FIGS. 1-7. Of course, however, the method 800 may be carried out in any desired environment. Again, it should also be noted that the aforementioned definitions may apply during the present description.

As shown in operation 802, an interactive response is received. In one embodiment, the interactive response may be received by an interactive system. Further, the interactive response may be received from a user system, a content system, an advertisement system, or any other system on a network capable of being in communication with the interactive system.

Additionally, the interactive response may include a response to an interactive request. Optionally, additional information may be included in the response. Still yet, such additional information may include information requested by the interactive request.

In response to the receipt of the interactive response, it is determined whether the interactive response is a fuzzy response. Note decision 804. The fuzzy response may include an imprecise response, an ambiguous response, etc. Just by way of example, the fuzzy response may include a range of values as opposed to a particular value.

If it is determined that the interactive response is a fuzzy response, a conclusion is created, as shown in operation 806. The conclusion may include a response to an objective of a strategy. For example, if an objective of a strategy is to determine an age of a user, the conclusion may be an age of the user determined based on the fuzzy response.

In one embodiment, the conclusion may be determined utilizing intuition. Optionally, the conclusion may be determined by randomly choosing a definitive response from the fuzzy response. Just by way of example, if the fuzzy response includes an age range for the user, the intuitive conclusion may include one of the ages in the age range. As another option, the intuitive conclusion may include a fuzzy conclusion. For example, the fuzzy conclusion may reflect the information in the fuzzy response.

In another embodiment, the conclusion may be determined utilizing reasoning. For example, the conclusion may be determined based on fuzzy knowledge. Thus, fizzy knowledge may be utilized to analyze and/or process the fuzzy response, such that a definitive conclusion may be identified.

If it is determined that the interactive response is not a fuzzy response, it is determined whether the interactive response is incomplete or contradictory, as shown in decision 808. In one embodiment, the interactive response may be determined to be incomplete if a conclusion is incapable of being determined based on the interactive response. For example, if the interactive request includes a request for the user's age, the associated interactive response may be incomplete if such response does not indicate the user's age.

In another embodiment, the interactive response may be determined to be contradictory if the interactive response includes information that contradicts other information in the interactive response. Thus, if the interactive response indicates two different ages for the user, the interactive response may be determined to be contradictory. If the response is neither incomplete nor contradictory, a conclusion is created based on the interactive response (operation 506).

If, however, the interactive response is either incomplete or contradictory, it is determined whether additional information is to be obtained. Note operation 810. Such determination may be made based on any desired criteria. In one embodiment, the determination may be made based on a predetermined timeout criterion. For example, if a conclusion has not been created within a predetermined period of time, additional information may not be obtained, and the method 800 may end.

In response to a determination that additional information is to be obtained, an interactive request for the additional information is sent, as shown in operation 812. As an option, the interactive request may be sent to a system on a network that is different than the system from which the interactive response was originally received (in operation 802). As another option, the interactive request may be refined with respect to a previous interactive request from which the original interactive response was received. Thus, in another embodiment, the interactive request may be sent to the same system from which the interactive response was originally received. In this way, another interactive response may be received (operation 802), such that a conclusion may at least potentially be created based on such interactive response.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying, at an interactive system, a user request for digital information from a user system;
in response to the user request, sending interactive requests for additional information from the interactive system to the user system and a third party system;
generating a response to the user request, utilizing the additional information; and
sending the response from the interactive system to the user system.

2. The method of claim 1, wherein the digital information includes a web page.

3. The method of claim 1, wherein the user request includes a request by a user to receive the digital information over a network.

4. The method of claim 1, wherein the interactive system includes a server separate from the user system.

5. The method of claim 1, wherein the interactive system is a component of the user system.

6. The method of claim 1, wherein the interactive requests include queries for the additional information.

7. The method of claim 1, wherein the additional information includes information associated with the user system.

8. The method of claim 1, wherein the additional information includes advertisement information.

9. The method of claim 1, wherein the third party system stores content.

10. The method of Claim I, wherein the response to the user request includes the digital information.

11. The method of claim 1, wherein the response to the user request includes an advertisement.

12. The method of claim 1, wherein the response to the user request is customized to the user system based on at least a portion of the additional information.

13. The method of claim 1, wherein the interactive requests are sent in response to a lack of sufficient information associated with the user request.

14. The method of claim 1, wherein the interactive requests are sent in response to contradictory information associated with the user request.

15. The method of claim 1, wherein the interactive requests are sent based on a strategy.

16. The method of claim 1, wherein a relationship between the user system and the interactive system is selected from the group consisting of cooperative and uncooperative.

17. The method of claim 1, wherein the relationship changes over time.

18. A computer program product embodied on a computer readable medium, comprising:
computer code for identifying, at an interactive system, a user request for digital information from a user system;
computer code for sending interactive requests for additional information from the interactive system to the user system and a third party system, in response to tile user request;
computer code for generating a response to the user request, utilizing the additional information; and
computer code for sending the response from the interactive system to the user system.

19. A system, comprising:
logic for identifying, at an interactive system, a user request for digital information from a user system;
logic for sending interactive requests for additional information from the interactive system to the user system and a third party system, in response to the user request;
logic for generating a response to the user request, utilizing the additional information; and
logic for sending the response from the interactive system to the user system.

20. The system of claim 19, wherein the logic is carried out utilizing a processor that is coupled to memory via a bus.
